(19) United States
(12) Patent Application Publication
(10) Pub. No.: US 2010/0288693 A1
(43) Pub. Date: Nov. 18, 2010

(54) SEQUENTIAL BIOLOGICAL REACTOR HAVING A SELECTOR FOR THE TREATMENT OF MUNICIPAL OR INDUSTRIAL WASTEWATERS

(75) Inventors: Patrick Vion, Houilles (FR); Robert Gellin, Arhus C Denmark (DK)

Correspondence Address: CONNOLLY BOVE LODGE & HUTZ LLP, 1875 EYE STREET, N.W., SUITE 1100, WASHINGTON, DC, 20006, US

(73) Assignee: DEGREMONT, RUEIL-MAIMAISON (FR)

(21) Appl. No.: 12/681,138

(22) PCT Filed: Oct. 1, 2008
(86) PCT No.: PCT/FR08/01365

§ 371 Date: Jul. 13, 2010

(30) Foreign Application Priority Data
Oct. 2, 2007 (FR) 0706893

(51) Int. Cl. C02F 3/12; B01D 21/08

(52) U.S. Cl. 210/521

(57) ABSTRACT

Sequential biological reactor (R), comprising: a tank (1) delimited by a base and peripheral walls (3); an inlet (11) equipped with a selector (S) that determines a baffled route with contacting of the effluent to be treated and a portion (5) of the recirculated sludges; a means (6) for discharging the treated water in the top part of the water surface of the tank, and an outlet (7) for discharging the excess sludges in the bottom of the tank. The selector (S) comprises a vessel (8) placed in the tank (1) at a distance from the peripheral walls (3); the vessel is compartmentalized into several sectors (8.1, 8.2, 8.3, 8.4), the outlet from one sector, which is also the inlet of the following sector, being alternately low and high, or vice versa, and a last step is defined by a chamber (13) formed by two partitions (14, 15) that extend between the wall of the vessel (8) and the peripheral walls (3) of the tank and that surround the top outlet (12) of the last sector of the vessel, the lower edge of the partitions being at a distance from the base and determining two low openings for passage of the effluent into the tank.

The invention relates to a sequential biological reactor for the treatment of municipal or industrial wastewater by activated sludge, said reactor being of the kind of those which comprise:
a basin bounded by a floor and peripheral walls;
an inlet equipped with a selector that determines a baffled path with the effluent to be treated coming into contact with a portion of the recirculated sludge;
a means for discharging the treated water at the top of the water surface of the basin; and
an outlet for discharging the excess sludge into the bottom of the basin.

A reactor of this kind makes it possible to treat carbon by itself or in combination, carbon and total nitrogen (recommended application), combined, depending on the case, with physico-chemical and/or biological removal of phosphorus.

Because such a reactor operates in sequential mode, with a variable water level, a treatment plant generally consists of several reactors, or cells, so as to ensure continuity of the feed, in a predetermined sequence of operations constituting a cycle, namely: filling and reaction, settling, draining. The treated water is discharged during the draining phase according to the water level.

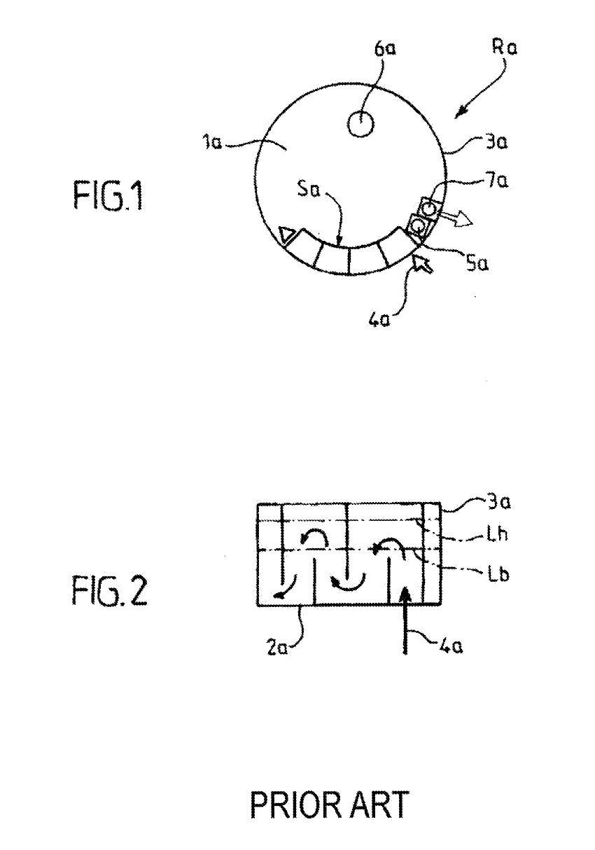

An example of a reactor according to the prior art is shown in FIGS. 1 and 2 of the appended drawings. The sequential biological reactor Ra comprises a basin 1a of cylindrical shape, having a circular horizontal cross section in the example in question. This shape could be different, especially rectangular or square. The basin is bounded by a floor 2a and a vertical peripheral wall 3a.

The reactor includes an inlet 4a for the effluent to be treated, said inlet being equipped with a selector Sa that determines a vertical baffled path with the effluent to be treated coming into contact with a recirculated portion 5a of the sludge. A means 6a, shown schematically in the form of a shovel, is provided for discharging the treated water in the top of the water surface of the basin and an outlet 7a is provided in the bottom of the basin for removing the excess sludge.

### Filling of the Reactor and Reaction

The raw water or primary settled water arrives via the inlet 4a in a zone located at the top of the selector Sa that extends over a circular sector. The selector comprises vertical radial walls, creating the baffles, which are fastened to the peripheral wall of the basin (the selector may be on the inside or the outside of the basin 1). The effluent to be treated is brought into contact with the recirculated portion 5a of the sludge coming from the basin 1a.

During filling, the liquid level in the basin 1a rises from a low level Lb (FIG. 2) to a high level Lh. The activated sludge is aerated by conventional means, for example air injection diffusers or nozzles (not shown) in the bottom of the reactor.

The biological treatment of the effluent takes place mainly during the reaction phase:
elimination of the carbon and nitrification of the ammoniacal nitrogen during the aeration period; and
denitrification during the optional anoxic period.

### Settling

The filling, the aeration and/or the stirring of the effluent in the basin 1a are then stopped for a predetermined period. It is during this period that the separation of the treated water from the sludge takes place, in purely static settling mode. A certain biological activity continues with endogenous denitrification of the liquid in contact with the sludge bed.

### Draining

The supernatant clarified water is discharged by means of an uptake system (for example a shovel) 6a which follows the water level. The thickening of the sludge bed and the endogenous denitrification within it continue. The excess biological sludge is extracted at the end of the draining period.

This type of reactor has several advantages:
compactness of the plant, thanks to the elimination of the clarifier(s). This is because clarification does not take place in a separate construction, but in each reactor in an alternating manner. This results in a significant reduction in floor area of the plants;
control of the “bulking” (formation of bacterial balls which float): through its principle of operation, the reactor allows feeding and “starving” sequences, thereby promoting the development of flocculated forms to the detriment of filamentary bacteria responsible to a certain extent for the “bulking”; and
optimum settling of the sludge; settling is optimum since it is static, with no hydraulic perturbation, the sludge index (SI) being better than in conventional activated sludge treatment, with the absence of transfer from one basin to another, hence rejection of suspended matter (SM) of very good quality.

### Advantage of the Selector

The selector Sa placed at the top of the reactor plays a very important role. The selector is a nonaerated contact area with a high sludge loading, which is located upstream of the main reactor and in which the effluent to be treated is brought into contact with a portion of the recirculated biological sludge.

The selector Sa, through its characteristics (baffled plug flow, hydraulic residence time, high sludge loading) thus makes it possible:
to reduce the risks of sludge expansion by limiting or preventing the growth of filamentary bacteria developing with a low sludge loading;
to improve the sludge settling capability (reduction in sludge index SI);
to promote hydrolysis of the pollution and storage of soluble substrate and, consequently, to promote denitrification and biological dephosphatizing reactions in the system.

However, the construction cost of a selector is not negligible and this penalizes plants, especially small or average-size plants. The use of the selector substantially complicates a construction, which is very simple at the start, and as a consequence significantly increases the cost.

The dimensions of sequential biological reactors are substantial. By way of indication, the diameter of a circular reactor may be up to 40 m, while in the case of a rectangular reactor its length may exceed 50 m. The height of the walls of the basin is generally between 5 and 7 meters. The selector represents 5 to 15% of the overall volume.

The object of the invention is in particular to provide a reactor of the kind defined above which is equipped with a selector which is less expensive to produce, while still meeting the hydraulic constraints of the reactor and of the process.

These constraints are in particular the following:
come as close as possible to plug flow, with baffles and a minimum of dead zones, while seeking to minimize the volume of the selector;
a sufficient number of baffles in order not to create substantial settling phenomena, even with a low flow rate;
a selector outlet via the bottom with the largest possible cross section so that, during the draining phase, the volume of the selector corresponding to the drop in the water level does not create, during its flow through the reactor, a hydraulic stream that resuspends the sludge during settling phases.

Current reactors according to the prior art have limitations:
the selector is generally made up of at least 4 elements, at least two of which must keep to the hydraulic water loading during the filling or draining phases. These differential loadings result in substantial local stresses on the civil engineering and require the structure of the floor and the thickness of the walls to be overdesigned, especially in the case of circular reactors;
the outlet cross section of the selector for the inflow of the effluent into the reactor is limited in terms of height (its maximum height generally corresponds to ⅕ of the total height) and in terms of width, which is defined by hydraulic and process parameters.

According to the invention, to solve these problems the sequential biological reactor as defined above is characterized in that:
the selector comprises a tank placed in the basin at a certain distance from the peripheral walls;
the tank is compartmentalized into several sector's, the outlet from one sector, which is also the inlet of the following sector, being alternately at the bottom and at the top, or conversely, the outlet of the tank is always at the top; and
a final stage is defined by a chamber formed by two partitions which extend between the wall of the tank and the peripheral walls of the basin and which flank the top outlet of the last sector of the tank, the lower edge of the partitions being at a certain distance from the floor and determining two bottom openings for the effluent to flow into the basin.

Advantageously, the tank forming the selector is cylindrical, with vertical generatrices. The tank may be placed on or fixed to the floor of the basin, or erected on this floor. The tank may be produced in one of the following materials: concrete, metal, plastic.

The number of sectors compartmentalizing the selector tank may be between 2 and 8, preferably equal to 4.

The feed for the first sector of the selector tank is at the top for an even number of sectors or at the bottom for an odd number.

The partitions defining the chamber connect, without linking it, the external surface of the selector to the walls of the basin. Advantageously, the partitions are formed by plastic or wooden plates mounted in vertical grooves or slideways provided in the respective walls of the selector and of the basin.

Preferably, the chamber defined by the partitions has a cross section at least equivalent to that of each of the sectors of the selector. In the case of a basin with a cylindrical peripheral wall, the feed axis of the chamber is advantageously perpendicular to the wall of the tank. The same applies for a rectangular basin if the tank is not in a corner. If the tank is placed in a corner of a rectangular basin, the feed axis is advantageously at 45°.

Partial hydraulic pressure equilibration holes may be provided in the bottom part of the walls of the selector sectors. At least one partial equilibration hole to the outside may be provided in the bottom part of the wall of the last sector of the selector.

Apart from the abovementioned arrangements, the invention consists of a certain number of other arrangements which will be more explicitly discussed with regard to embodiments described with reference to the appended drawings, although these are in no way limiting. In these drawings:

FIG. 1 is a schematic top view of a sequential biological reactor having a selector according to the prior art;

FIG. 2 is a schematic side view of the reactor of FIG. 1;

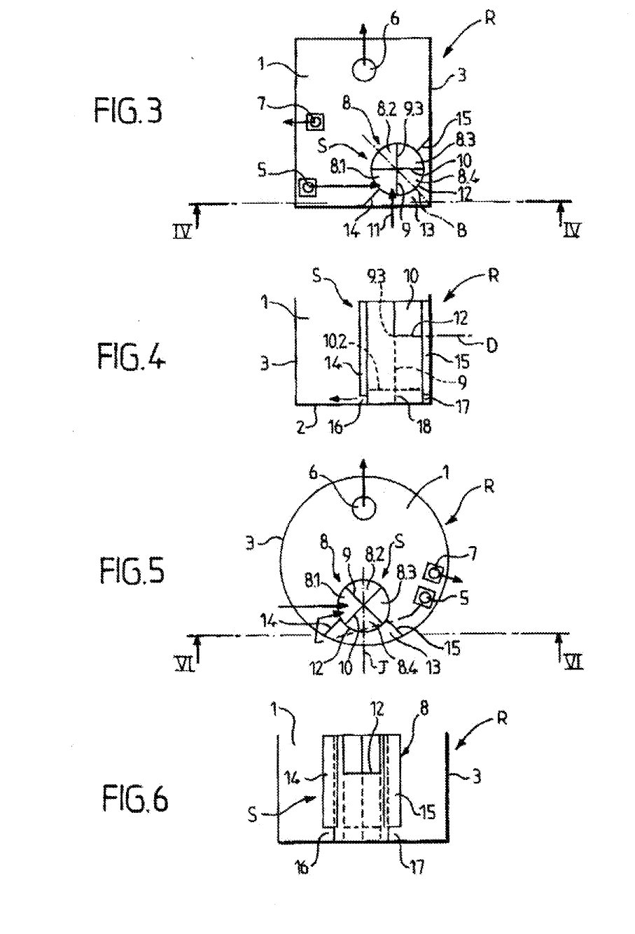

FIG. 3 is a schematic plan view of a rectangular reactor according to the invention;

FIG. 4 is a schematic cross section on the line IV-IV of FIG. 3;

FIG. 5 is a schematic plan view of a circular reactor according to the invention; and

FIG. 6 is a schematic cross-sectional view on the line VI-VI of FIG. 5.

Shown in FIGS. 3 and 4 is a sequential biological reactor R according to the invention. The parts of this reactor playing similar roles to those of the reactor Ra of FIGS. 1 and 2 are denoted by the same reference letters or numbers, but without the letter a. These will not be described again or will only be described briefly.

In the embodiment shown in FIGS. 3 and 4, the basin 1 has a rectangular shape.

According to the invention, the selector S comprises a tank 8 placed in the basin 1 at a certain distance from the peripheral walls 3. The tank 8 is preferably cylindrical, with a circular cross section, having vertical generatrices. It may be placed, i.e. simply positioned on the floor 2, or erected on this floor during construction of the basin. The tank 8 may be prefabricated from concrete, metal or another material, especially a plastic. The tank 8 is made of concrete when it is produced with the floor. When the tank 8 is placed on the floor, means for fastening the tank to the floor may also be provided.

The height of the tank 8 is at least equal to that of the peripheral walls 3 of the basin in such a way that the upper part of the tank 8 remains above the highest water level in the basin 3. The bottom of the cylindrical part of the tank 8 may be open, the contact between the cylindrical wall of the tank 8 and the floor establishing a sufficient separation between the interior of the tank and the basin 1. When the tank is attached, it may also have a bottom. In general, the top part of the tank is open to the atmosphere, but a cover could be provided.

The cylindrical shape of the tank 8 is not limiting, it being possible for example for this tank to be prismatic with a polygonal cross section.

The tank 8 is compartmentalized into several sectors. The number of sectors is generally between 2 and 8, this number preferably being equal to 4 as illustrated in FIGS. 3 and 4. The sectors 8.1, 8.2, 8.3 and 8.4 are defined by two orthogonal diametral partitions 9, inside the tank 8. Four 90° sectors are thus defined, each with the same flow area.

The effluent to be treated may be fed via a pipe 11 which opens into the first sector 8.1. The same applies to the recirculated portion 5 of the sludge. A feed via the pipe 11 takes place in the upper part of the first sector 8.1 as illustrated in FIGS. 3 and 4 for an even number of sectors of the tank 8, as will be explained below.

The outlet of one sector, which is also the inlet of the following sector, is alternately at the bottom and the top, or conversely.

In the example shown in FIGS. 3 and 4, the inflow into the sector 8.1 takes place in the upper part. The outflow, i.e. the flow from the sector 8.1 into the sector 8.2, takes place in the lower part via a passage located beneath the lower edge 10.2 (FIG. 4) of the wall 10, said lower edge being located at a certain distance above the bottom of the basin. The wall 9 descends right down to the bottom of the basin. The liquid stream is therefore descending in the sector 8.1, passing beneath the lower edge 10.2 (FIG. 4) and ascending in the sector 8.2. The upper edge 9.3 of the wall 9 between the sectors 8.2 and 8.3 is located at a level D (FIG. 4) slightly lower than the hydraulic low level Lb (see the diagram shown in FIG. 2), whereas the wall 10 extends upwards as far as this upper end. The flow from the sector 8.2 into the sector 8.3 takes place via the top of the edge 9.3 and the stream is descending in the sector 8.3, passing, in the bottom part, beneath the edge 10.2 and ascending in the sector 8.4.

The inlets and outlets, whether at the top or the bottom, for the various sectors are arranged in such a way that the dead zones, i.e. zones in which the liquid is stationary, are minimized.

The outlet 12 (FIG. 4) of the last sector 8.4 of the tank 8 is necessarily at the top and is formed, for example, by a circularly arcuate edge located at the level D, slightly lower than the hydraulic low level Lb of the tank 8.

A final step of the selector is defined by a chamber 13 formed by two partitions 14, 15 that extend between the wall of the tank 8 and the peripheral walls 3 of the basin. The partitions 14, 15 flank the top outlet 12 of the final sector 8.4 of the tank. The vertical partitions 14; 15 extend as far as the top end of the tank but stop, at the lower part at a certain distance from the bottom of the basin in order to leave two lower passages 16, 17 (FIG. 4) that bring the chamber 13 into communication with the basin 1 on either side of the tank 8. The outflow from the selector S via the bottom into the basin 1 therefore takes place with a large cross section equal to the sum of the cross sections of the passages 16, 17.

The chamber 13 is thus bounded by a sector of the external wall of the cylindrical tank 8 and by the two partitions 14, 15 which may be lightweight and connect, without linking them, the tank 8 to the peripheral walls 3 of the basin 1. The partitions 14, 15 may be produced in the form of plates, especially made of plastic or wood, which are mounted in vertical grooves or slideways. The chamber 13 corresponding to the final step of the selector has a cross section equivalent to that of each of the sectors 8.1-8.4 of the tank 8, or may be slightly larger.

Because the outlets 16, 17 of the chamber 13 for flow into the basin 1 must be in the lower part, the feed for the first sector 8.1 must be in the upper part when the number of sectors of the tank 8 is even, or in the lower part when this number is odd. The same applies to the recirculated portion 5 of the sludge.

In the embodiment shown in FIGS. 3 and 4, the partitions 14, 15, which may lie one in the extension of the other, extend between the circular outline of the tank 8 and two peripheral walls of the basin that are at right angles to each other. The direction of the feed into the chamber 13 is preferably at 45°, i.e. along the bisector B of the right angle of the basin 1 where the tank 8 is located.

FIGS. 5 and 6 show an alternative embodiment of the reactor R in which the basin 1 is circular. The various parts of the reactor and of the selector that are similar to the parts described with regard to FIGS. 3 and 4 are denoted by the same numerical references and therefore they will not be described again. The tank 8 is located in the basin 1 at a certain distance from the peripheral wall 3. The partitions 14, 15 are oriented so as to be substantially radial to the center of the circular section of the tank 8. The feed direction J of the chamber 13 passes through the center of the section of the tank 8 and is perpendicular to the wall of this tank.

Because of the arrangement adopted, the feed into the basin 1 via the outlets 16, 17 is doubled and enlarged by the geometry. The benefit of such a feed is that it enables the basin 1 to be fed at a rate 2 to 3 times lower than in the version according to the prior art and means that the turbulent zones can be distributed. This arrangement thus makes it possible to improve the operational safety of the reactor, especially when it operates close to the maximum throughput. In the end, greater quality of the treated water is obtained.

To minimize the thickness of the internal walls 9, 10 of the tank 8 forming the selector, partial equilibration holes 18 are placed at the base of the wall 9 or 10. Likewise, to minimize the thickness of the walls of the cylindrical tank 8, a partial equilibration hole to the outside may be produced in the base of the final sector 8.4.

The solution of the invention has several advantages.

The selector S with tank 8 fulfils the same functions under the same conditions as a conventional selector with the advantage that the feed into the basin 1 takes place at a 2 to 3 times slower rate, preventing the sludge bed from rising during the draining phase.

The technique of producing the selector S with an independent tank 8, in particular a cylindrical tank, placed in a rectangular or circular, flat basin 1, makes it possible:
for the forces on the selector S not to be transmitted to the peripheral walls 3 of the tank, hence a saving on the wall thicknesses;
for the selector S to be produced with thinner walls when a cylindrical form is adopted for the tank 8;
for the tank 8 to be produced in prefabricated form or made of various materials, with a saving in production time.

When the tank 8 is made of concrete, the tank 8 and the basin 1 may be produced at the same time, hence also a saving in construction time.

Finally, the reactor construction cost saving may be more than 10% and the construction time reduced by several weeks.

1. A sequential biological reactor for the treatment of municipal or industrial wastewater by activated sludge, which reactor comprises:
a basin bounded by a floor and peripheral walls;
an inlet equipped with a selector (S) that determines a baffled path with the effluent to be treated coming into contact with a portion of the recirculated sludge;
a means for discharging the treated water at the top of the water surface of the basin; and
an outlet for discharging the excess sludge into the bottom of the basin, wherein:
the selector comprises a tank (8) placed in the basin (1) at a certain distance from the peripheral walls (3);
the tank is compartmentalized into several sectors (8.1, 8.2, 8.3, 8.4), the outlet from one sector, which is also the inlet of the following sector, being alternately at the bottom and at the top, or conversely, the outlet of the tank being necessarily at the top; and
a final stage is defined by a chamber (13) formed by two partitions (14, 15) which extend between the wall of the tank (8) and the peripheral walls (3) of the basin and which flank the top outlet (12) of the last sector of the tank, the lower edge of the partitions being at a certain distance from the floor and determining two bottom openings (16, 17) for the effluent to flow into the basin.

2. The reactor as claimed in claim 1, wherein the tank (8) forming the selector is cylindrical, with vertical generatrices.

3. The reactor as claimed in claim 1, wherein the tank (8) forming the selector is fixed to the floor (2) of the basin.

4. The reactor as claimed in claim 1, wherein the tank (8) forming the selector is erected on the floor (2).

5. The reactor as claimed in claim 1, wherein the tank of the selector is produced in one of the following materials: concrete, metal, plastic.

6. The reactor as claimed in claim 1, wherein the number of sectors compartmentalizing the selector tank (8) is between 2 and 8.

7. The reactor as claimed in claim 6, wherein the number of sectors compartmentalizing the selector tank (8) is equal to 4.

8. The reactor as claimed in claim 1, wherein the feed (11) for the first sector of the selector tank is at the top for an even number of sectors or at the bottom for an odd number.

9. The reactor as claimed in claim 1, wherein the partitions (14, 15) defining the chamber (13) connect, without linking it, the external surface of the selector to the walls of the basin.

10. The reactor as claimed in claim 1, wherein the partitions (14, 15) are formed by plastic or wooden plates mounted in vertical grooves or slideways provided in the respective walls of the selector and of the basin.

11. The reactor as claimed in claim 1, wherein the chamber (13) defined by the partitions has a cross section at least equivalent to that of each of the sectors of the selector.

12. The reactor as claimed in claim 1, comprising a basin with a cylindrical peripheral wall (or a rectangular peripheral wall if the tank (8) is not in the corner), wherein the feed axis (J) of the chamber (13) is perpendicular to the wall of the tank (8).

13. The reactor as claimed in claim 1, comprising a basin having a rectangular peripheral wall with the tank (8) in one corner, wherein the feed axis (J) of the chamber (13) is at 45°.

14. The reactor as claimed in claim 1, wherein holes (18) for partial equilibration of the hydraulic pressure are provided in the bottom part of the walls of the sectors of the selector.

15. The reactor as claimed in claim 1, wherein at least one hole for partial equilibration to the outside is provided in the bottom part of the wall of the last sector of the selector.
